(19) United States
(12) Patent Application Publication
(10) Pub. No.: US 2016/0068989 A1
(43) Pub. Date: Mar. 10, 2016

(54) AGITATOR

(71) Applicant: ROLLS-ROYCE PLC, London (GB)

(72) Inventors: Andrew HEWITT, Derby (GB); Lloyd PALLETT, Derby (GB); William GRIFFITHS, Derby (GB)

(21) Appl. No.: 14/824,638

(22) Filed: Aug. 12, 2015

(30) Foreign Application Priority Data
Sep. 10, 2014 (GB) 1415980.0

(51) Int. Cl. C25D 21/14; B01F 11/00; C25D 5/04; B01F 15/02

(52) U.S. Cl. CPC C25D 21/14; B01F 15/026; B01F 11/0082; C25D 5/04

(57) ABSTRACT

The present invention provides an agitator for agitating a liquid (e.g. an electrolyte solution) containing particles (e.g. abrasive particles) within a tank. The agitator comprises an agitator body having an upper surface and a lower surface with at least one aperture extending through the agitator body. There is a one-way valve for allowing liquid flow through at least one aperture from the upper surface to the lower surface and for blocking liquid flow through at least one aperture from the lower surface to the upper surface.

### FIELD OF THE INVENTION

The present invention relates to an agitator for use in an apparatus for depositing a particles contained within a liquid onto a component. For example, the agitator may be for use in an apparatus for depositing abrasive particles entrained within an electrolyte solution onto a rotary blade tip.

### BACKGROUND OF THE INVENTION

It is known to provide gas turbine engine components such a turbine/compressor blades or seal fin tips with an abrasive coating. Blades provided with an abrasive coating on their tips are able to minimise tip clearance between the blades and surrounding casing with reduced risk of over-heating and blade/casing damage, by cutting into an abradable layer on the casing.

The abrasive coating is usually applied by electrodeposition of a metal ions (usually nickel and/or cobalt ions) from an electrolyte solution containing dissolved metal ions to form a metal matrix. Abrasive particles (e.g. particles of cubic boron nitride, silicon nitride, aluminium nitride, alumina, zirconia, sapphire) are suspended in the solution and tacked into the metal matrix. A mixture of large (50-175 micron) and finer (5-15 micron) particles are typically used with the finer particles acting to fill in around the large particles.

To coat the component (i.e. blade tip), the tip is suspended within a plating tank containing the electrolyte solution with the suspended particles. As described in U.S. Pat. No. 3,830,711, the tank is fitted with a horizontal perforated agitator that is reciprocated in a generally vertical direction to raise the particles within the solution so that they can fall and settle onto the suspended component.

One problem with this known agitator is that the upstroke creates turbulence within the solution which results in disrupted falling of the particles within the electrolyte solution so that they are unevenly deposited onto the component. The turbulence may also wash off particles already deposited onto the component leading to increased processing times being necessary to achieve the required extent of particle deposition. The downstroke of the agitator (which forces the solution and thus the particles upwards) is inefficient owing to the perforations in the agitator.

Accordingly, there is a need for a more efficient agitator that reduces turbulence within the electrolyte solution containing the particles.

### SUMMARY OF THE INVENTION

In a first aspect, the present invention provides an agitator for agitating a liquid within a tank, said agitator comprising:
an agitator body having an upper surface and a lower surface with at least one aperture extending through the agitator body; and
a one-way valve for allowing liquid flow through at least one aperture from the upper surface to the lower surface and for blocking liquid flow through at least one aperture from the lower surface to the upper surface.

In a second aspect, the present invention provides an apparatus for forming a particulate coating on a component, said apparatus comprising:
a tank for housing a liquid containing particles;
an agitator according to the first aspect for agitating the liquid within the tank; and
a driver for reciprocating the agitator.

By providing an agitator that has a one-way valve that only allows liquid to pass through the agitator body in one direction i.e. from the upper surface side to the lower surface side, the downstroke of the agitator within the tank has increased efficiency because flow through the agitator body from the lower surface side to the upper surface side is blocked and thus a greater pumping force can be generated by the agitator body. Conversely, on the upstroke, flow through the aperture in the agitator body is allowed from the upper surface side to the lower surface size so that the pumping force and thus the turbulence is reduced allowing a more even deposition of particles and a reduced processing time.

Optional features of the invention will now be set out. These are applicable singly or in any combination with any aspect of the invention.

In some embodiments, the agitator body is a plate e.g. a generally horizontal plate. The plate may be a circular plate. The profile of the plate preferably matches the horizontal cross-sectional profile of the tank albeit of a smaller dimensions. For example, the tank may be a cylindrical tank with a cross-sectional radius greater than that of the circular plate.

In some embodiments, there are a plurality of apertures through the agitator body/plate. In some embodiments, the or each aperture is petal-shaped and may extend from a central hub on the agitator body. The surface area of the aperture(s) may be at least 30% of the surface area of the upper (or lower) surface of the agitator body.

In some embodiments, the one-way valve comprises at least one sealing plate which is moveable between a closed position for blocking the aperture or one or more of the plurality of apertures through the agitator body (e.g. by abutting the lower surface of the agitator body) and an open position for opening the aperture or one or more of the plurality of apertures through the agitator body (e.g. by being at least partly spaced from the agitator body). The or each sealing plate is dimensioned to have a greater area that the aperture or the one or more of the plurality of apertures that it is intended to block in the closed position. The or each sealing plate may be petal-shaped and may have a greater length and width than the respective petal-shaped aperture.

In some embodiments, the or each sealing plate is connected to the agitator body (e.g. to the lower surface of the agitator body) by a respective hinge and the or each sealing plate is pivotable about its respective hinge between the open and closed positions. The petal-shaped sealing plate(s) may be hinged to the lower surface of the agitator body at the central hub.

Movement of the agitator in the downstroke forces the sealing plate(s) to pivot into abutment with the lower surface of the agitator body to seal the aperture(s) and prevent liquid flow through the apertures. Movement of the agitator in the upstroke forces the sealing plate(s) to pivot away from the lower surface of the agitator body to open the aperture(s) and allow liquid flow through the apertures.

In some embodiments, the agitator body has a peripheral edge comprising an upstanding skirt portion. On the downstroke, the liquid and entrained particles are forced upwards between the skirt portion and the walls of the tank. This channelling of the liquid and particles by the skirt portion increases the velocity of the liquid flow and thus increases circulation of the particles to the upper levels of the tank.

The skirt portion may extend in a generally vertical direction (e.g. perpendicularly from a horizontal plate agitator body) or the skirt portion may be flared away from the perpendicular in either direction. The skirt portion may extend generally linearly from the agitator body or it may extend in a curved profile e.g. the skirt portion may comprise a curved lip portion distal the agitator body. There may be a curved transition between the agitator body and the skirt portion.

The skirt portion may be the same height, or of greater height than the distance the agitator moves on its downstroke, or upstroke. The component may be located within a volume bounded by the skirt and located such that the it is bounded by the skirt when the agitator is in its lowermost travelled position and its uppermost travelled position.

The presence of the skirt helps to control the direction of the flow of the fluid past the component. i.e. on the downstroke of the agitator body the entrained particles can be directed beyond the component whilst the flow is isolated from the component by the skirt. This can lead to a more controlled deposition

In some embodiments, the agitator further comprises at least one connector for connecting it to the driver. The connector may comprise one or more rods extending from the agitator body. For example, a rod may extend from the central hub of the agitator body or a number of rods may extend from the peripheral edge of the agitator body.

In a third aspect, the present invention provide a method of coating a component with a particulate coating, said method comprising,
providing an apparatus according to the second aspect;
adding a liquid containing dissolved metal ions and particles to the tank;
suspending the component within the liquid;
driving reciprocal movement of the agitator within the liquid; and
passing an electric current through the liquid and component.

In some embodiments, the particles are abrasive particles.

In some embodiments, the component is a rotary blade tip.

In some embodiments, the reciprocal movement of the agitator is in a vertical direction.

In a fourth aspect, the present invention provides a rotary blade or a seal fin having a portion coated using the method according to the third aspect.

### BRIEF DESCRIPTION OF THE DRAWINGS

Embodiments of the invention will now be described by way of example with reference to the accompanying drawings in which:

FIG. 1 shows a first embodiment of the agitator moving in a downstroke within a tank; and

FIG. 2 shows the first embodiment of the agitator moving in an upstroke within the tank.

### DETAILED DESCRIPTION AND FURTHER OPTIONAL FEATURES OF THE INVENTION

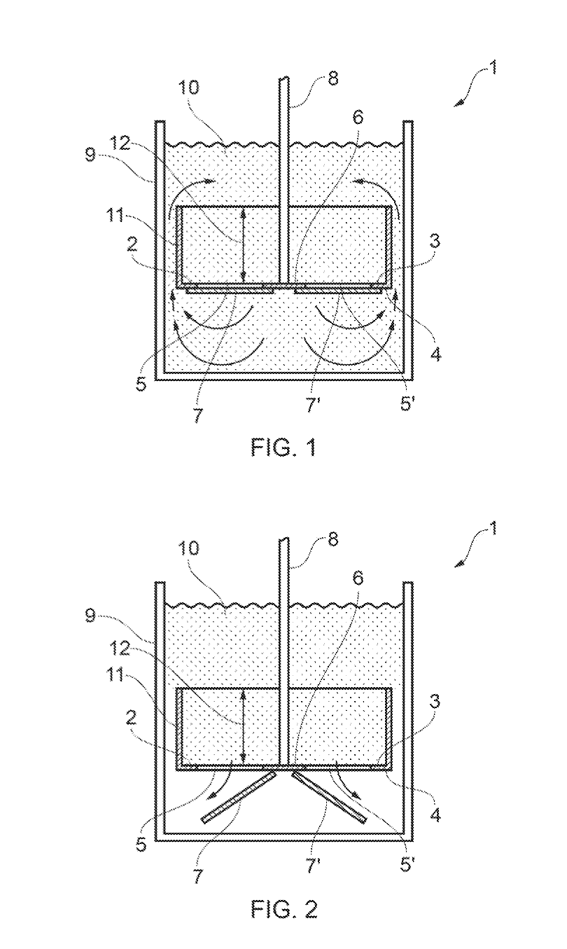

As shown in FIG. 1, the agitator 1 comprises an agitator body formed of a generally horizontal, circular plate 2. The plate 2 has an upper surface 3 and a lower surface 4 with a series of petal shaped apertures 5, 5′ extending out from a central hub 6 of the circular plate 2. The surface area of the apertures 5, 5′ is greater than 50% of the area of the circular plate 2.

Each aperture 5 is provided with a respective petal shaped sealing plates 7, 7′ which is hingedly connected to the lower surface 4 at the central hub 6. The hinged sealing plates 7, 7′ have greater dimensions (width/length) than the respective aperture 5, 5′. The hinged sealing plates 7, 7′ form a one-way valve which allows liquid flow through the apertures 5, 5′ from the upper surface 3 to the lower surface 4 and blocks liquid flow through the apertures 5, 5′ from the lower surface 4 to the upper surface 3 as discussed below.

The circular plate 2 has a generally vertically-extending upstanding skirt portion 10 extending around its periphery.

The agitator 1 has a central rod 8 for connection to a driver (not shown) for driving the circular plate in a generally vertical reciprocal motion.

The agitator 1 is positioned within a tank 9 containing an electrolyte solution 10 (e.g. nickel sulphamate solution at a temperature of 50° C. and pH 4.0). The tank is generally cylindrical with a circular cross-section that has a larger radius than the radius of the circular plate 2.

A component e.g. a rotary blade tip is suspended in the electrolyte solution and the driver moves the agitator 1 at a speed of around 0.75 Hz with a stroke of 33.5 mm whilst an electric current is passed through the electrolyte solution and component.

As the driver moves the circular plate 2 in a downstroke as shown in FIG. 1, the sealing plates 7, 7′ are pivoted on their hinges into abutment with the lower surface 4 of the circular plate 2. As they are larger in size than the respective apertures 5, 5′, the sealing plates seal the apertures 5, 5′ and block flow of the electrolyte solution and particles through the circular plate 2.

The pumping force generated by the downstroke of the circular plate 2 forces the electrolyte solution and entrained particles upwards between the skirt portion 10 and the walls of the tank 9. The skirt portion 10 channels the electrolyte solution and entrained particles and thus increases the velocity of flow to that the particles are carried to the upper levels of electrolyte solution within the tank 9 before falling under gravity to be deposited onto the component.

As the driver moves the circular plate 2 in an upstroke as shown in FIG. 2, the sealing plates 7, 7′ are pivoted on their hinges away from the lower surface 4 of the circular plate 2 thus allowing flow of the electrolyte solution and particles through the plate 2 with minimal resistance and thus minimal turbulence. This in turn allows a more even deposition of particles on the component and a reduced processing time.

The distance of travel of the circular plate 12 may be the same as, or less than, the length of the skirt 11. This helps to control the direction of the flow of the fluid past the component. i.e. on the downstroke of the agitator body the entrained particles can be directed beyond the component whilst the flow is isolated from the component by the skirt. This can lead to a more controlled deposition.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting.

All references referred to above are hereby incorporated by reference.

1. An agitator for agitating a liquid within a tank, said agitator comprising:
an agitator body having an upper surface and a lower surface and at least one aperture extending through the agitator body; and
a one-way valve for allowing liquid flow through at least one aperture from the upper surface to the lower surface and for blocking liquid flow through at least one aperture from the lower surface to the upper surface; and the agitator body has a peripheral edge comprising an upstanding skirt portion.

2. An agitator according to claim 1 wherein the agitator body is a generally horizontal plate.

3. An agitator according to claim 2, comprising a plurality of apertures through the agitator body.

4. An agitator according to claim 3, wherein the at least one or plurality of apertures have a surface area that is at least 30% of the surface area of the upper surface of the agitator body.

5. An agitator according to claim 1, wherein the one-way valve comprises at least one sealing plate which is moveable between a closed position for blocking the at least one aperture or one or more of the plurality of apertures through the agitator body and an open position for opening the at least one aperture or one or more of the plurality of apertures through the agitator body.

6. An agitator according to claim 5, wherein the or each sealing plate is connected to the lower surface of the agitator body by a respective hinge and the or each sealing plate is pivotable about its respective hinge between the open and closed positions.

7. An agitator according to claim 1, wherein the skirt portion extends in a generally vertical direction from the agitator body.

8. An agitator according to claim 7, wherein the agitator has a travel length equal to the distance the agitator moves in use, wherein the distance the skirt extends in the vertical direction is equal to or greater than the travel length.

9. An agitator according to claim 7 wherein the skirt portion comprises a curved lip portion distal the agitator body.

10. An apparatus for forming a particulate coating on a component, said apparatus comprising:
a tank for housing a liquid containing particles;
an agitator for agitating the liquid within the tank, the agitator comprising an agitator body having an upper surface and a lower surface and at least one aperture extending through the agitator body; and
a one-way valve for allowing liquid flow through at least one aperture from the upper surface to the lower surface and for blocking liquid flow through at least one aperture from the lower surface to the upper surface; and the agitator body has a peripheral edge comprising an upstanding skirt portion; and
a driver for reciprocating the agitator.

11. An apparatus according to claim 10 wherein the agitator body is a plate having a shape matching the horizontal cross-sectional shape of the tank but of smaller dimensions.

12. An apparatus according to claim 10, wherein the skirt portion extends in a generally vertical direction from the agitator body.

13. An agitator according to claim 12, wherein the agitator has a travel length equal to the distance the agitator moves in use, wherein the distance the skirt extends in the vertical direction is equal to or greater than the travel length.

14. A method of coating a component with a particulate coating, said method comprising, providing an apparatus comprising:
a tank for housing a liquid containing particles;
an agitator for agitating the liquid within the tank, the agitator comprising an agitator body having an upper surface and a lower surface and at least one aperture extending through the agitator body; and
a one-way valve for allowing liquid flow through at least one aperture from the upper surface to the lower surface and for blocking liquid flow through at least one aperture from the lower surface to the upper surface; and the agitator body has a peripheral edge comprising an upstanding skirt portion; and
a driver for reciprocating the agitator;
adding a liquid containing dissolved metal ions and particles to the tank;
suspending the component within the liquid;
driving reciprocal movement of the agitator within the liquid; and
passing an electric current through the liquid and component.

15. A method according to claim 16 wherein the particles are abrasive particles.

16. A method according to claim 14 wherein the component is a rotary blade tip.

17. A method according to any claim 14 wherein the reciprocal movement of the agitator is in a vertical direction.

18. A method according to claim 17, where in the distance the agitator travels in one stroke of its reciprocal movement is less than or equal to the length of the upstanding skirt.

19. A rotary blade or a seal fin having a portion coated using the method according to claim 14.
